(19) United States
(12) Patent Application Publication
(10) Pub. No.: US 2018/0250899 A1
(43) Pub. Date: Sep. 6, 2018

(54) CONTACT LENS AND METHOD FOR MAKING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/615,250

(22) Filed: Jun. 6, 2017

(30) Foreign Application Priority Data
Mar. 1, 2017 (TW) 106106686

(51) Int. Cl. B29D 11/00; B29C 35/08; B29C 37/00

(52) U.S. Cl. CPC B29D 11/00923; B29C 35/08; B29D 11/00903; B29C 2037/0046; B29D 11/00038; B29C 2037/0035; B29C 2035/0827; B29C 37/0028

(57) ABSTRACT

A contact lens comprises a transparent pupil region and an iris region surrounding the pupil region. The iris region comprises a colored pattern portion. A plurality of pigments are dispersed in the colored pattern portion. The disclosure also provides a method for making a contact lens.

### FIELD

The subject matter herein generally relates to a contact lens and a method for making the contact lens.

### BACKGROUND

Colored contact lenses are commonly worn by users to correct vision, or for cosmetic or therapeutic reasons. A colored contact lens usually comprises a substrate and a colored ink film formed on the substrate. However, forming the colored ink film on the substrate may be complicated and costly.

### BRIEF DESCRIPTION OF THE DRAWINGS

Implementations of the present technology will now be described, by way of example only, with reference to the attached figures.

FIG. 1 is a cross-sectional view of an exemplary embodiment of a contact lens.

FIG. 2 is a flowchart of an exemplary embodiment of a method for making a contact lens.

FIG. 3 is a cross-sectional view of a mold used in the method of FIG. 2.

FIG. 4 is a cross-sectional view showing a female die and a male die of the mold core of FIG. 3 being engaged.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

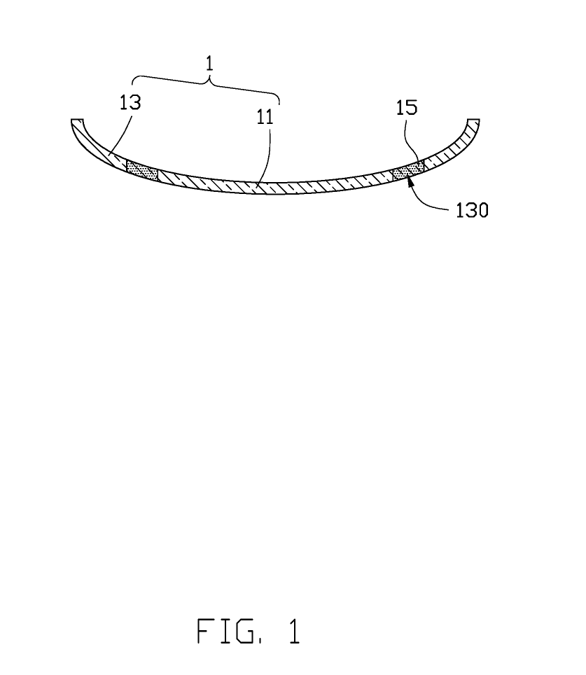

FIG. 1 illustrates an exemplary embodiment of a contact lens 1. The contact lens 1 comprises a transparent pupil region 11 and a substantially annular iris region 13 surrounding the pupil region 11. The iris region 13 comprises a colored pattern portion 130. For blue contact lens, prussian blue pigments 15 are dispersed in the colored pattern portion 130. For other colored contact lens, other pigment colors may be used, such as silver chloride.

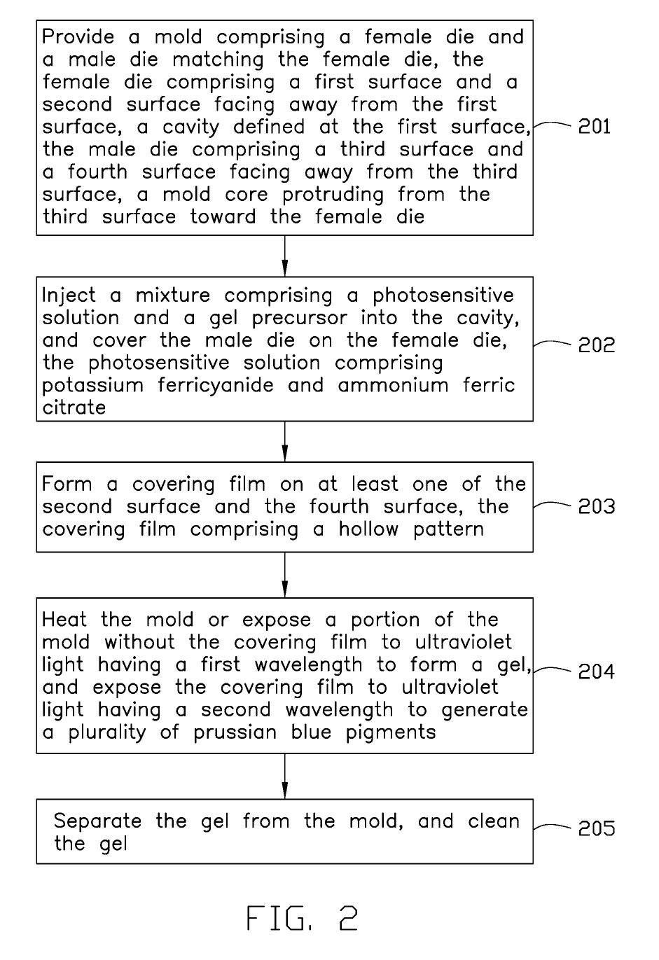

FIG. 2 illustrates a flowchart of a method for making a contact lens 1 in accordance with an exemplary embodiment. The exemplary method is provided by way of example, as there are a variety of ways to carry out the method. Each block shown in FIG. 2 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 201.

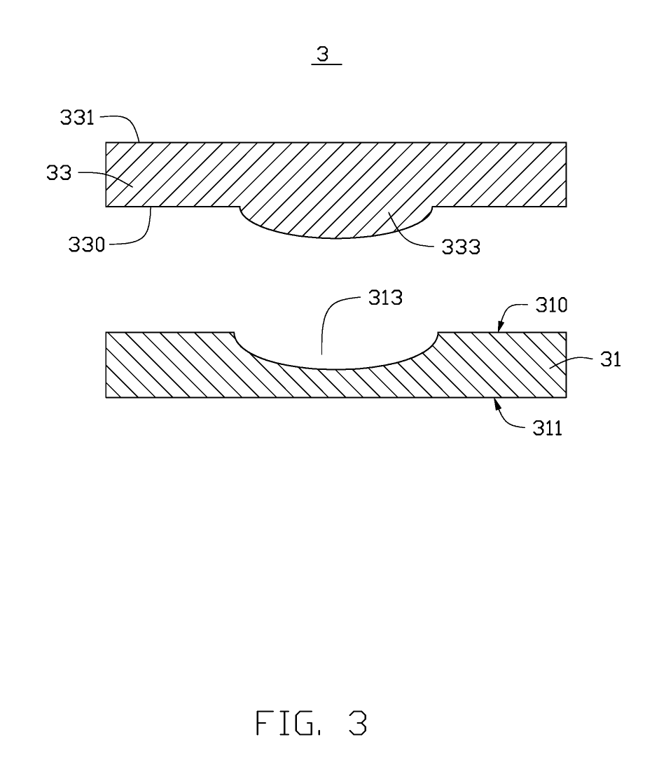

At block 201, referring to FIG. 3, a mold 3 is provided which comprises a female die 31 and a male die 33 matching the female die 31.

The female die 31 comprises a first surface 310 and a second surface 311 facing away from the first surface 310. A cavity 313 is defined at the first surface 310. The male die 33 comprises a third surface 330 and a fourth surface 331 facing away from the third surface 330. A mold core 333 protrudes from the third surface 330. The mold core 333 matches the cavity 313. The mold 3 is made of a material which the ultraviolet radiation can pass through.

At block 202, a mixture is injected into the cavity 313, and then the male die 33 is covered on the female die 31. The mixture comprises a photosensitive solution and a gel precursor. The photosensitive solution and the gel precursor are in a ratio of about 2:3 to about 4:1 by volume.

The photosensitive solution comprises deionized water, potassium ferricyanide, and ammonium ferric citrate. The potassium ferricyanide and the ammonium ferric citrate are dissolved in the deionized water. The potassium ferricyanide and the ammonium ferric citrate are in a ratio of 1:1 by weight.

The gel precursor comprises hydrophilic monomers, a cross-linking agent, and an initiator. In at least one exemplary embodiment, the hydrophilic monomers have a mass percentage of about 40% to about 98% of a total mass of the gel precursor. The cross-linking agent has a mass percentage of about 0.1% to about 15% of a total mass of the gel precursor. The initiator has a mass percentage of about 0.05% to about 46% of a total mass of the gel precursor.

The hydrophilic monomers may be selected from a group consisting of methacryloxyalkylsiloxanes, 3-methacryloxypropylpentamethyldisiloxane, bis(methacryloxypropyl)tetramethyl-disiloxane, monomethacrylatedpolydimethylsiloxane, mercapto-terminatedpolydimethylsiloxane, N-[tris(trimethylsiloxy)silylpropyl]acrylamide, N-[tris(trimethylsiloxy)silylpropyl]methacrylamide, tris(pentamethyldisiloxyanyl)-3-methacrylatopropylsilane (T2), 3-methacryloxypropyletris(trimethylsiloxy)silane, 2-hydroxyethylmethacrylate (HEMA), hydroxyethyl acrylate, hydroxypropyl acrylate, hydroxypropyl methacrylate (HPMA), trimethylammonium 2-hydroxy propylmethacrylate hydrochloride, dimethylaminoethyl methacrylate (DMAEMA), dimethylaminoethylmethacrylamide, acrylamide, methacrylamide, allyl alcohol, vinylpyridine, glycerol methacrylate, N-(1,1dimethyl-3-oxobutyl)acrylamide, N-vinyl-2-pyrrolidone (NVP), acrylic acid, methacrylic acid, and N,N-dimethyacrylamide (DMA).

The cross-linking agent may be selected from a group consisting of ethylene glycol dimethacrylate (EGDMA), trimethylolpropane trimethacrylate (TMPTMA), tri(ethylene glycol) dimethacrylate (TEGDMA), tri(ethylene glycol) divinyl ether (TEGDVE), and trimethylene glycol dimethacrylate.

The initiator may be a photoinitiator or a thermal initiator.

The photoinitiator may be selected from a group consisting of benzoin methyl ether, diethoxyacetophenone, a benzoylphosphine oxide initiator, ethyl 2-dimethylaminobenzoate, 2-isopropylthioxanthone, 1-hydroxycyclohexyl phenyl ketone, Darocur type initiator and Irgacur type initiator. The photoinitiator can absorb ultraviolet light having a first wavelength. The photosensitive solution can absorb ultraviolet light having a second wavelength. The first wavelength is different from the second wavelength. In at least one exemplary embodiment, the photoinitiator may be Irgacure-819. The benzoylphosphine oxide initiator may be selected from a group consisting of 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide.

The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), and peroxide. The peroxide can be benzoyl peroxide.

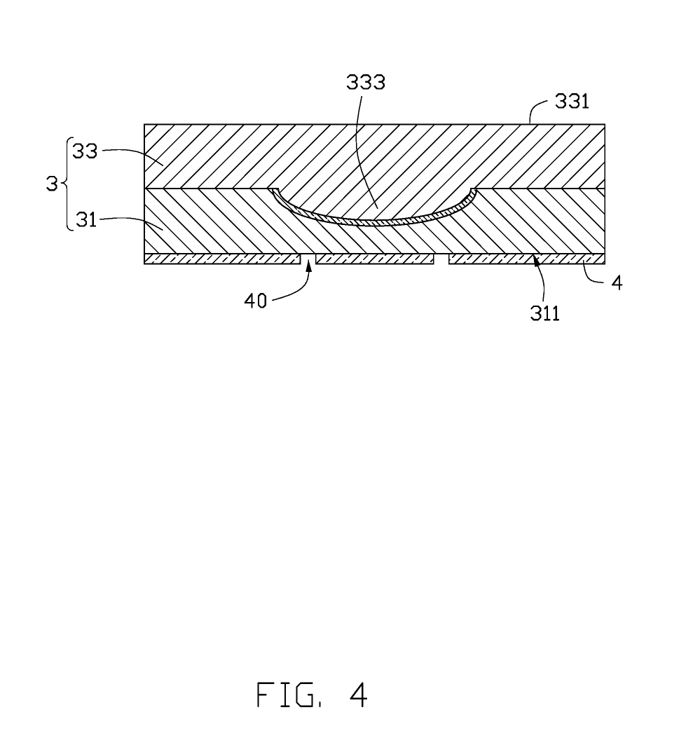

At block 203, referring to FIG. 4, a covering film 4 is formed on at least one of the second surface 311 and the fourth surface 331. The covering film 4 comprises a hollow pattern 40 corresponding to the iris region 3. In the illustrated exemplary embodiment, the covering film 4 is only formed on the second surface 311.

In at least one exemplary embodiment, the hollow pattern 40 is substantially annular. In another exemplary embodiment, the shape of the hollow pattern 40 may be varied. For example, the hollow pattern 40 may comprise a plurality of concentric rings.

At block 204, the mold 3 is heated, or a portion of the mold 3 without the covering film 4 is exposed to ultraviolet light having the first wavelength, to cause the gel precursor to undergo a polymerization reaction to form a gel. Furthermore, the covering film 4 is exposed to ultraviolet light having the second wavelength, to cause a portion of the photosensitive solution corresponding to the hollow pattern 40 to generate prussian blue pigments 15. The prussian blue pigments 15 are dispersed in the gel to cause a portion of the gel corresponding to the hollow pattern 40 to show blue color.

In at least one exemplary embodiment, the mold 3 is heated or exposed to the ultraviolet light having the first wavelength for about 0.5 min to about 60 min. The covering film 4 is exposed to the ultraviolet light having the second wavelength for about 0.1 min to about 10 min. The second wavelength is about 355 nm to about 375 nm. A temperature for heating is from about 50 degree centigrade to about 90 degree centigrade.

At block 205, the gel with the prussian blue pigments 15 is separated from the mold 3, and is cleaned to remove any unreacted photosensitive solution, thereby forming the contact lens 1.

In another exemplary embodiment, the photosensitive solution comprises deionized water, silver nitrate, and sodium chloride. The silver nitrate and the sodium chloride are in a ratio of 1:1 by weight. When the covering film 4 is exposed to a light having the second wavelength, to cause a portion of the photosensitive solution corresponding to the hollow pattern 40 to generate silver chloride pigments 15. The second wavelength is about 500 nm to about 560 nm.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A contact lens comprising:
a transparent pupil region; and
an iris region surrounding the pupil region;
wherein the iris region comprises a colored pattern portion, and a plurality of pigments are dispersed in the colored pattern portion.

2. The contact lens of claim 1, wherein the pigments are selected from silver chloride or prussian blue.

3. A method for making a contact lens, the contact lens comprising a transparent pupil region and an iris region surrounding the pupil region, the method comprising:
providing a mold comprising a female die and a male die matching the female die, the female die comprising a first surface and a second surface facing away from the first surface, a cavity defined at the first surface, the male die comprising a third surface and a fourth surface facing away from the third surface, a mold core protruding from the third surface toward the female die;
injecting a mixture comprising a photosensitive solution and a gel precursor into the cavity;
covering the male die on the female die;
forming a covering film on at least one of the second surface and the fourth surface, the covering film comprising a hollow pattern corresponding to the iris region; and
heating the mold or exposing a portion of the mold without the covering film to ultraviolet light having a first wavelength, to cause the gel precursor to undergo a polymerization reaction to form a gel, and exposing the covering film to a light having a second wavelength different from the first wavelength, to cause a portion of the photosensitive solution corresponding to the hollow pattern to generate a plurality of pigments, wherein the pigments are dispersed in the gel.

4. The method of claim 3, wherein the photosensitive solution and the gel precursor are in a ratio of 2:3 to 4:1 by volume.

5. The method of claim 3, wherein the mold is heated or exposed to the ultraviolet light for 0.5 min to 60 min.

6. The method of claim 3, wherein the covering film is exposed to the light for 0.1 min to 10 min.

7. The method of claim 3, wherein the photosensitive solution comprising potassium ferricyanide and ammonium ferric citrate, the pigments are prussian blue.

8. The method of claim 7, wherein the potassium ferricyanide and the ammonium ferric citrate are in a ratio of 1:1 by weight.

9. The method of claim 7, wherein the second wavelength is 355 nm to 375 nm.

10. The method of claim 3, wherein the photosensitive solution comprising silver nitrate and the sodium chloride, the pigments are silver chloride.

11. The method of claim 10, wherein the silver nitrate and the sodium chloride are in a ratio of 1:1 by weight.

12. The method of claim 10, wherein the second wavelength is 500 nm to 560 nm.

13. The method of claim 3, wherein the gel precursor comprises hydrophilic monomers, a cross-linking agent, and an initiator.

14. The method of claim 13, wherein the hydrophilic monomers have a mass percentage of 40% to 98% of a total mass of the gel precursor, the cross-linking agent has a mass percentage of 0.1% to 15% of a total mass of the gel precursor, the initiator has a mass percentage of 0.05% to 46% of a total mass of the gel precursor.
